(19) United States
(12) Patent Application Publication
(10) Pub. No.: US 2025/0379365 A1
(43) Pub. Date: Dec. 11, 2025

(54) PHASE SHIFTING APPARATUS AND PROCESS

(71) Applicant: The Penn State Research Foundation, University Park, PA (US)

(72) Inventor: Wooram Lee, State College, PA (US)

(21) Appl. No.: 19/229,414

(22) Filed: Jun. 5, 2025

Related U.S. Application Data
(60) Provisional application No. 63/656,868, filed on Jun. 6, 2024.

(51) Int. Cl. H01Q 13/20; H01Q 1/52; H01Q 3/30

(52) U.S. Cl. CPC H01Q 13/206; H01Q 1/521; H01Q 3/30

(57) ABSTRACT

A phase shifting apparatus and process can be configured to provide enhanced control of time delays associated with transmission of data while also helping to avoid data loss that may occur via the transmission of data. Embodiments can be configured to account for frequency to control for time delay and also help avoid data loss via transmission of data that can occur along multiple parallel transmission lines that can be interconnected to teach other via a series of switches, for example. In some embodiments, the transmission lines and switches can be positioned in a chip (e.g. nanochip, microchip, transmission device chip, radio frequency chip, semiconductor on insulator chip, etc.) that can be included in an electronic device (e.g. telecommunication device, computer system, control system, etc.).

### CROSS-REFERENCE TO RELATED APPLICATIONS

The present application claims priority to U.S. Provisional Patent Application No. 63/656,868, which was filed on Jun. 6, 2024. The entirety of this application is incorporated by reference herein.

### BACKGROUND

There is abundant spectrum available at millimeter-wave (mmWave) frequency bands, which can deliver extreme channel capacity for communications and ultrahigh resolution for radar sensing. This motivated the recent deployment of the fifth-generation (5G) mmWave mobile network in the range of 24-40 GHz and the commercialization of high-resolution mmWave radar sensors at 60 and 76-81 GHz for industrial and automotive applications, for example.

A large-scale phased array transceiver is often used to overcome severe path loss and limited performance of silicon-based Radio Frequency Integrated Circuits (RFICs) at mmWave frequencies. Such arrays can utilize a very large number of antenna elements that are integrated into a massive multiple-input multiple-output (MIMO) array module to enable multiple signals to be sent and received simultaneously to boost spectral efficiency.

### SUMMARY

Due to the small available area in the antenna-in-package (AiP) of such arrays, a very compact integrated circuit (IC) area per element, and a low power consumption for mitigation of heat density are often design constraints that affect such arrays. Also, array calibration is often needed to help ensure the arrays provide accurate beam pointing. Signal-to-noise (SNR) degradation due to beam broadening may also be addressed in array designs by providing accurate beam-pointing functionality. This can be particularly true for designs that may utilize a narrow beamwidth.

I have developed embodiments of an apparatus for phase shifting and process for phase shifting that can help address a number of design constraints affecting mmWave frequency band utilization for transmission of data. Some embodiments can be configured to provide (1) bi-directional phase control with a compact chip area so that transmitter (TX) and receiver (RX) front-ends can share a single phase shifter, (2) a passive phase shifter with low insertion loss to reduce power consumption, and (3) a calibration-free, accurate phase control and constant insertion loss over phase tuning. Some embodiments can provide all three of these features. Other embodiments can provide only one of these features or a combination of two of these three features. Yet other embodiments can include a combination of one, two or three of these three features as well as other features.

For example, some embodiments of the apparatus for phase shifting can be configured to provide a D-band passive phase shifter design that can achieve bi-directional and calibration-free operation with low insertion loss, high phase control accuracy, and compact area. Embodiments of the apparatus can have a relatively simple architecture that can be configured to manipulate propagation delay through multiple parallel transmission lines (e.g. two parallel transmission lines) periodically connected via transistor switch networks. As discussed herein, an exemplary embodiment of such an apparatus was developed as a prototype phase shifter that can operate with 11.25° steps over 360° at 140 GHz, in a 45-nm RF silicon-on-insulator (SOI) process. Other embodiments may be provided that can utilize other operational capacity for another type of chip or radio frequency process (e.g. operate on another type of sized chip platform, operate at a different bandwidth or bandwidth range, operate at a different degree of steps over 360°, etc.).

Some embodiments are configured as a phase shifting apparatus. Embodiments of the apparatus can include a first transmission line, a second transmission line, and a plurality of spaced apart unit cells positioned between the first transmission line and the second transmission line. The plurality of spaced apart unit cells can include at least one first unit cell, a second unit cell, at least one third unit cell, and at least one fourth unit cell. Each of the unit cells can include at least one first switch positioned between the first transmission line and the second transmission line. The at least one first switch can be configured to adjust between an on position and an off position. The at least one first switch can be configured so that, in the off position, the at least one first switch avoids coupling the first transmission line to the second transmission line, and, in the on position, the at least one first switch couples the first transmission line to the second transmission line to form a transmission line connection between the first transmission line and the second transmission line so data is passable from the first transmission line to the second transmission line along a transmission path of travel. A second switch can be positionable adjacent the at least one first switch. The second switch can be adjustable between an on position that couples the at least one first switch to ground and an off position that prevents the second switch from coupling the at least one first switch to the ground. Each of the unit cells can be adjustable into multiple different modes of operation. The modes of operation can include a propagation mode, a connection mode, and a short mode. The propagation mode can be a mode in which the at least one first switch is in the off position and the at least one second switch is in the on position. The connection mode can be a mode in which the at least one first switch is in the on position to form the transmission line connection and the second switch is in the off position. The short mode can be a mode in which the at least one first switch is in the on position and the second switch is in the on position. The unit cells can be positioned and configured so that the at least one first unit cell is positionable in the propagation mode, the second unit cell is positionable in the connection mode, the at least one third unit cell is positionable in the propagation mode, and the at least one fourth unit cell is positionable in the short mode.

In some embodiments, the at least one first switch includes at least one transistor and the second switch includes a transistor. For example, in some embodiments the at least one first switch can include at least one metal-oxide semiconductor (NMOS) transistor and the second switch can include a NMOS transistor.

In some embodiments, the at least one first unit cell includes between two first unit cells and seven first unit cells, the second unit cell includes a single second unit cell, the at least one third unit cell includes between one third unit cell and four third unit cells, and the at least one fourth unit cell includes between nine fourth unit cells and five fourth unit cells. Other embodiments may utilize other numbers of different unit cells as well.

In some embodiments, the second unit cell is between the at least one first unit cell and the at least one third unit cell and the at least one third unit cell is between the second unit cell and the at least one fourth unit cell.

In some embodiments, the at least one first switch includes multiple first switches arranged in series. For example, in some embodiments, the at least one first switch includes two first switches arranged in series.

In some embodiments, the apparatus can be integrated into a D-band phased array transceiver.

A phase shifter apparatus can also be provided. The apparatus can include a first transmission line, a second transmission line, and a plurality of spaced apart unit cells positioned between the first transmission line and the second transmission line. Each of the unit cells can include at least one first switch positioned between the first transmission line and the second transmission line. The at least one first switch can be configured to adjust between on position and an off position. The at least one first switch can be configured so that, in the off position, the at least one first switch avoids coupling the first transmission line to the second transmission line, and, in the on position, the at least one first switch couples the first transmission line to the second transmission line to form a transmission line connection between the first transmission line and the second transmission line so data is passable from the first transmission line to the second transmission line along a transmission path of travel. A second switch can be positionable adjacent the at least one first switch. The second switch can be adjustable between an on position that couples the at least one first switch to ground and an off position that prevents the second switch from coupling the at least one first switch to the ground. Each of the unit cells can be adjustable into multiple different modes of operation including a propagation mode, a connection mode, and a short mode. The propagation mode can be a mode in which the at least one first switch is in the off position and the at least one second switch is in the on position, the connection mode can be a mode in which the at least one first switch is in the on position to form the transmission line connection and the second switch is in the off position, and the short mode can be a mode in which the at least one first switch is in the on position and the second switch is in the on position. The unit cells can be positioned and configured so that a single one of the unit cells is in the connection mode, more than two of the unit cells are in the propagation mode, and more than two of the unit cells are in the short mode.

In some embodiments, the at least one first switch includes at least one transistor and the second switch includes a transistor or the at least one first switch includes at least one metal-oxide semiconductor (NMOS) transistor and the second switch includes a NMOS transistor.

In some embodiments, the at least one first switch includes multiple first switches arranged in series. For instance, the at least one first switch can include two first switches arranged in series.

In some embodiments, the apparatus can be integrated into a D-band phased array transceiver.

A process of shifting a phase of a signal as the signal is passed from a first transmission line to a second transmission line can also be provided. Embodiments of the process can include passing a signal along a first transmission line, passing the signal along a transmission line connection between the first transmission line and the second transmission line provided by at least one first switch of a connection mode unit cell positioned between the first transmission line and the second transmission line. The second switch of the connection mode unit cell can be in an off position. The process can also include passing the signal from the transmission line connection to the second transmission line along a transmission path of travel, preventing a loss of data as the signal is passed from the first transmission line to the second transmission line along the transmission path of travel by configuring multiple unit cells positioned between the first transmission line and the second transmission line and also positioned downstream of the connection mode unit cell in a short mode of operation.

In some embodiments, the process can also include preventing a loss of data as the signal is passed from the first transmission line to the second transmission line along the transmission path of travel by configuring one or more unit cells located between the connection mode unit cell and the short mode unit cells in a propagation mode of operation

In some embodiments, there is at least one first unit cell positioned between the first transmission line and the second transmission line that is configured in a propagation mode and is located upstream of the connection mode unit cell.

Embodiments of the process can also include configuring one or more first unit cells upstream of the connection mode unit cell into a propagation mode and/or configuring one or more third unit cells positioned between the connection mode unit cell and the short mode unit cells into the propagation mode.

In some embodiments of the process, the propagation mode can include at least one first switch positioned between the first transmission line and the second transmission line being in an off position and a second switch positioned adjacent to the at least one first switch being in an on position to couple the at least one first switch to ground.

Other details, objects, and advantages of the invention will become apparent as the following description of certain exemplary embodiments thereof and certain exemplary methods of practicing the same proceeds.

### BRIEF DESCRIPTION OF THE DRAWINGS

Exemplary embodiments of a phase shifting apparatus and phase shifting process are shown in the accompanying drawings and certain exemplary methods of making and practicing the same are also illustrated therein. It should be appreciated that like reference numbers used in the drawings may identify like components.

FIG. 1 (also referred to herein as FIG. 1) is a schematic illustration of a first exemplary embodiment of the phase shifting apparatus.

FIG. 2 (also referred to herein as FIG. 2) is another schematic illustration of the first exemplary embodiment of the phase shifting apparatus with different unit cells 3 in different modes of operation (e.g. propagation mode PM, connection mode CM, and/or short mode SM).

FIG. 3 (also referred to herein as FIG. 3) is another schematic illustration of the first exemplary embodiment of the phase shifting apparatus with different unit cells 3 in different modes of operation (e.g. propagation mode PM, connection mode CM, and/or short mode SM).

FIG. 4 (also referred to herein as FIG. 4) is a schematic illustration of an exemplary embodiment of a unit cell 3 in a propagation mode PM.

FIG. 5 (also referred to herein as FIG. 5) is a schematic illustration of an exemplary embodiment of a unit cell 3 in a connection mode CM.

FIG. 6 (also referred to herein as FIG. 6) is a schematic illustration of an exemplary embodiment of a unit cell 3 in a short mode SM.

FIG. 7 (also referred to herein as FIG. 7) is a schematic perspective view of an exemplary embodiment of the phase shifting apparatus.

FIG. 8 (also referred to herein as FIG. 8) is a schematic illustration of another exemplary embodiment of the phase shifting apparatus with different unit cells 3 in different modes of operation (e.g. propagation mode PM, connection mode CM, and/or short mode SM).

FIG. 9 (also referred to herein as FIG. 9) is a schematic illustration of another exemplary embodiment of the phase shifting apparatus with different unit cells 3 in different modes of operation (e.g. propagation mode PM, connection mode CM, and/or short mode SM).

FIG. 10 (also referred to herein as FIG. 10) is a schematic illustration of impedance matching conditions at the transition between transmission lines for ideal switches and transistor switches for some exemplary embodiments.

FIG. 11 (also referred to herein as FIG. 11) is a schematic and 3-D layout view of a 1-bit phase shifter incorporated into a second prototype that was fabricated as an exemplary embodiment of the phase shifting apparatus 1. FIG. 11 also includes schematic images of small phase and large phase circuit models in two different phase settings (small phase of EN=0 and large phase of EN=1) that were utilized in experiments and simulations performed using the second prototype.

FIG. 12 (also referred to herein as FIG. 12) is a series of graphs illustrating simulated phase shift and insertion loss of a 1-bit fine tuning phase shifter with phase tuning of 0°/11.25° incorporated into a second prototype configured as a 5-bit phase shifter.

FIG. 13 (also referred to herein as FIG. 13) is a series of graphs illustrating simulated phase shift and insertion loss of a second prototype configured as a 1-bit fine tuning phase shifter with phase tuning of 0°/22.5° incorporated into a second prototype configured as a 5-bit phase shifter.

FIG. 14 (also referred to herein as FIG. 14) is a graph illustrating simulated insertion loss results for a second prototype configured as a 5-bit phase shifter at 140 GHz with respect to phase setting for different termination.

FIG. 15 (also referred to herein as FIG. 15) is a graph illustrating simulated phase step results for a second prototype configured as a 5-bit phase shifter at 140 GHz with respect to phase setting for different termination.

FIG. 16 (also referred to herein as FIG. 16) is a graph illustrating simulated insertion loss results for a second prototype configured as a 5-bit phase shifter at 140 GHz with respect to phase settings over different process, voltage, and temperature (PVT) variations.

FIG. 17 (also referred to herein as FIG. 17) is a graph illustrating simulated phase shift results for a second prototype configured as a 5-bit fine tuning phase shifter at 140 GHz with respect to phase settings for different PVT variations.

FIG. 18 (also referred to herein as FIG. 18) is a graph illustrating measured phase shift over frequency for all phase states for the second prototype.

FIG. 19 (also referred to herein as FIG. 19) is a graph illustrating measured phase shift at 135 GHZ, 140 GHz, and 145 GHz across phase settings for the second prototype.

FIG. 20 (also referred to herein as FIG. 20) is a series of graphs illustrating simulated and measured insertion loss for the second prototype.

FIG. 21 (also referred to herein as FIG. 21) is a series of graphs illustrating simulated and measured phase shift over frequency for all phase states for the second prototype.

FIG. 22 (also referred to herein as FIG. 22) is a graph illustrating a breakout measurement for the second prototype.

FIG. 23 (also referred to herein as FIG. 23) is a graph illustrating measured insertion loss at 140 GHz for different positive supply voltages (VDDs) with respect to phase settings for the second prototype.

FIG. 24 (also referred to herein as FIG. 24) is a graph illustrating rms phase errors with respect to frequency for 15 IC samples.

FIG. 25 (also referred to herein as FIG. 25) is a graph illustrating rms gain errors with respect to frequency for 15 IC samples.

FIG. 26 (also referred to herein as FIG. 26) is a graph illustrating measured large signal gain at 140 GHz with respect to input power for different phase states in comparison to simulation for the second prototype.

FIG. 27 (also referred to herein as FIG. 27) is a block diagram of an exemplary embodiment of a D-band transceiver front end that is integrated with an exemplary embodiment of the phase shifting apparatus 1.

### DETAILED DESCRIPTION

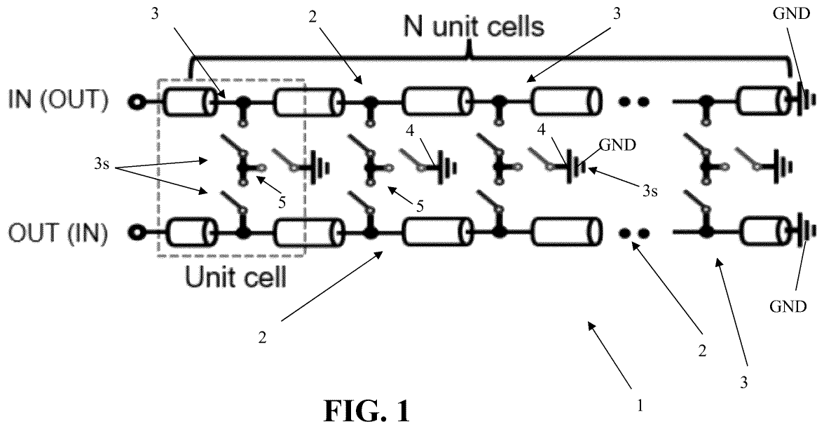

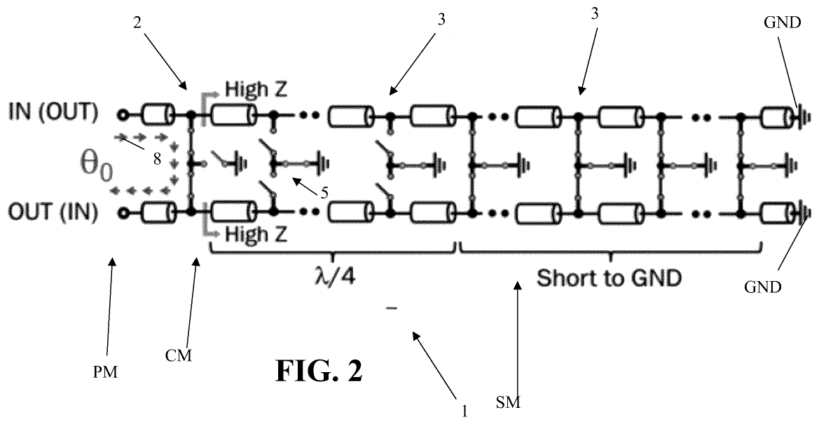

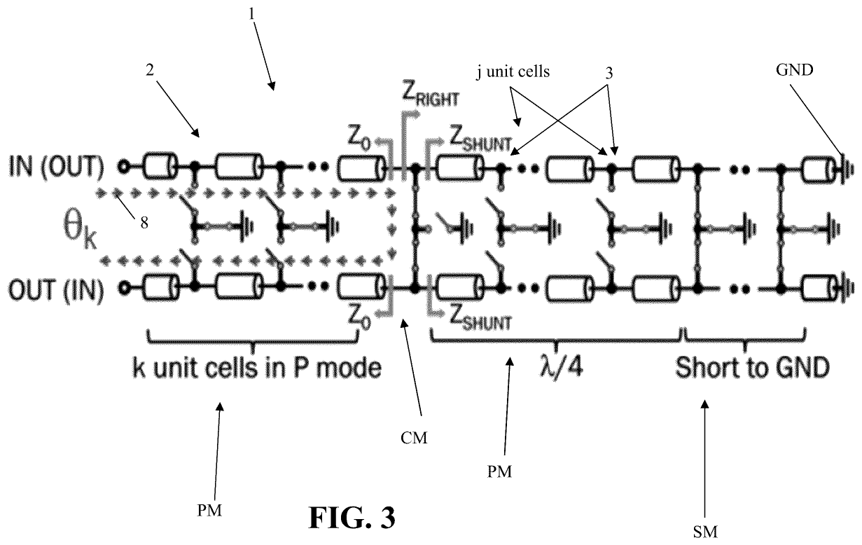

Referring to FIGS. 1-9, a phase shifting apparatus 1 can include a first transmission line 2 and a second transmission line 2. In some embodiments, each transmission line can include an electrically conductive element that can be surrounded by an insulating covering. In other embodiments, the transmission line 2 can be an electrically conductive member (e.g. metal elongated member incorporated into a chip or substrate, etc.). The length of the transmission line determines a time delay of the transmission of data (e.g. signal, current, voltage, other data) along the transmission line 2. Connection between the transmission lines can be provided by other elements (e.g. resistors, switches, etc.) that can be integrated into a transmission line or connected to the transmission line 2.

The phase shifter apparatus 1 can also include a plurality of spaced apart unit cells 3. Each cell 3 can be spaced apart from the other unit cells 3. Each unit cell 3 can include at least one first switch 3s positioned between the first and second transmission lines 2. Some embodiments may include only a first switch 3s while other embodiments can include a plurality of first switches 3s positioned in series (e.g. two first switches 3s arranged in series, etc.). Each first switch s3 can be adjustable between an on position in which the switch(es) 3s connects the first and second transmission lines 2 together for transmission of a voltage or current (e.g. electrical signal, etc.) and a second position in which the switch(es) 3s disengages so that the first and second transmission lines 2 are no longer electrically connected together via the switch(es) 3s. Each unit cell 3 can also include a second switch 3s that is positioned for electrically connecting the first switch(es) 3s to a ground GND (e.g. a grounding element, a ground line, etc.). The second switch 3s can be positioned at an intermediate location between the ground GND and the first switch(es) 3s and be adjustable between an on position that connects the first switch(es) 3s to the ground GND and an off position that decouples the first switch(es) 3s from the ground GND.

The first switch(es) 3s can provide a transmission line connection 4 when the first switch(es) 3s are in an on position to re-direct a transmission of data (e.g. an electrical current, voltage, a signal, and/or other data, etc.) from the first (second) to second (first) transmission lines 2. The second switch 3s can provide a shorting or ground connection 5 to ground that can function to provide a short to facilitate a reduction in data loss for data being passed along the transmission lines 2.

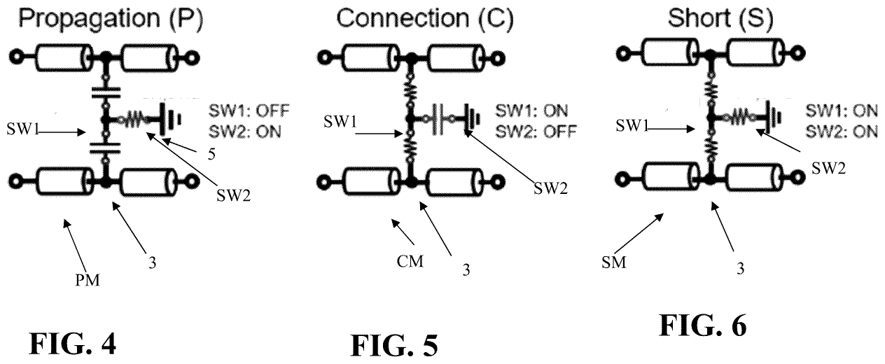

Each unit cell 3 can include at least one first switch SW1 and at least one second switch SW2 so that adjustments in the switch 3s positions between their on and off position can adjust a mode of operation for the unit cell 3. A phase shifting apparatus 1 can include multiple unit cells to facilitate adjustability in terms of the type of phase shift that the apparatus can provide. FIGS. 4, 5, and 6 may best illustrate the different modes of operation each unit cell 3 can have.

For instance, a unit cell 3 can be in a propagation (P) mode of operation, or propagation mode PM, of operation. In such a mode, the first switch SW1 can be off so that the transmission line connection 4 is not provided and the second switch SW2 can be on so that a connection to ground can be provided to the first switch SW1 between the first and second transmission lines to help prevent undesirable signal coupling between the two transmission lines (e.g. data loss or signal loss, etc.).

As may best be seen in FIG. 5, each unit cell 3 can also be adjustable into a connection (C) mode of operation, or connection mode CM. In the connection mode, the first switch(es) SW1 can be in an on position so that the transmission line connection 4 is formed so that data can pass between the first transmission line 2 and the second transmission line 2. The second switch SW2 can be in an off position so that there is no grounding connection provided by the second switch SW2, which can help facilitate the flow of data along the transmission line connection 4 between the transmission lines 2.

As may best be seen in FIG. 6, each unit cell 3 can also be adjusted into a short(S) position, or short mode SM. For example, the first switch(es) SW1 can be in an on position to form the transmission line connection 4 and the second switch SW2 can also be in the on position to connect the transmission line connection 4 to ground to provide a short.

Embodiments can be configured to utilize multiple parallel transmission lines connected via reconfigurable switches 3s of the unit cells 3. The unit cells 3 can provide digitally programmable propagation paths for the embodiment to facilitate an apparatus being configured for a particular design and/or being reconfigurable to account for different types of applications so the same apparatus design may be utilized for many different applications.

Embodiments of the phase shifter apparatus 1 can include a number N of unit cells. Some of the number N of unit cells can be in propagation mode PM, one of the unit cells can be in a connection mode CM, and yet other unit cells 3 downstream of the connection mode unit cell can be in short mode SM to provide increased impedance to help prevent data from being routed off the transmission path of travel 8 that can be defined by the propagation mode and connection mode unit cells as well as the first and second transmission lines extending between those cells.

In some embodiments, the apparatus can be configured so that there can be a first set of one or more upstream first unit cells that are in propagation mode PM, a second set of a single second unit cell that is in the connection mode CM, a third set of third unit cells that are also in propagation mode PM and are positioned downstream of the second unit cell that is in connection mode CM such that the second unit cell is between the first unit cells and the third unit cells, and a fourth set of unit cells that include one or more unit cells in a short mode SM. The first unit cell(s) can be positioned between an input of the first transmission line and an output for the second transmission line or the first unit cells can be positioned between an output of the first transmission line and an input of the second transmission line. The first unit cell(s) and the second unit cell can be positioned to help define a transmission path of travel 8 as data may be passed along the transmission path of travel that can be defined by the first unit cells and the second unit cell. The third unit cells and the fourth unit cell(s) can be positioned to help minimize or avoid data loss as data passes along the transmission path of travel 8. Embodiments can also be configured so that the phase shifting that may be provided for the transmission of the data can be passive (e.g. not require utilization of energy or a significant amount of electrical power).

Some embodiments can include two parallel transmission lines 2 that can be periodically connected via switch networks, which can be considered N-cascaded unit cells 3. Each unit cell 3 can be formed with two first switches 3s that connect the two parallel transmission lines and one second switch (3s) that can be configured as a shunt switch that can connects the middle node of the switch network to the ground GND. As noted above, each unit cell 3 can be configured in three different modes for operation—propagation mode, connection mode, and short mode.

In operation, when the switches are ideal (r_{ON}=0 and C_{OFF}=0), an input signal can propagate along a first transmission line 2 connected to the source of the input that can be formed with k first unit cells 3 in propagation mode PM until it reaches the second unit cell 3 that is in connection mode CM. Then, the signal can be redirected along the transmission line connection 4 provided by the second unit cell 3 in connection mode CM for subsequently propagating along the second transmission line 2 toward the output port to which the second transmission line is connected in a direction that is opposite the direction at which the signal was passed along the first transmission line 2 from the input port to the transmission line connection 4 of the unit cell in the connection mode CM configuration.

The total phase shift between the input and output ports to which the first and second transmission lines can be connected can be given by θₖ=(2k+1)τ₀*ω, where ω is resistance and τ₀ is the propagation delay per unit cell 3 and k is the integer value of the unit cells that are positioned upstream of the connection mode CM unit cell. The phase shift between the input and output ports can be programmable by selecting different k unit cells with phase steps of 2τ₀ω.

To help ensure that an input signal travels toward the output port without disruption after the transition (e.g. after the signal has passed along the transmission line connection 4 to the second transmission line 2), the impedance (Z) seen after the unit cell 3 in the connection mode CM, can be ∞ so that the signal sees only the characteristic impedance Z₀ continuously (Z_{RIGHT}=Z₀) for the transmission line and unit cells 3 downstream of the unit cell 3 in the connection mode CM.

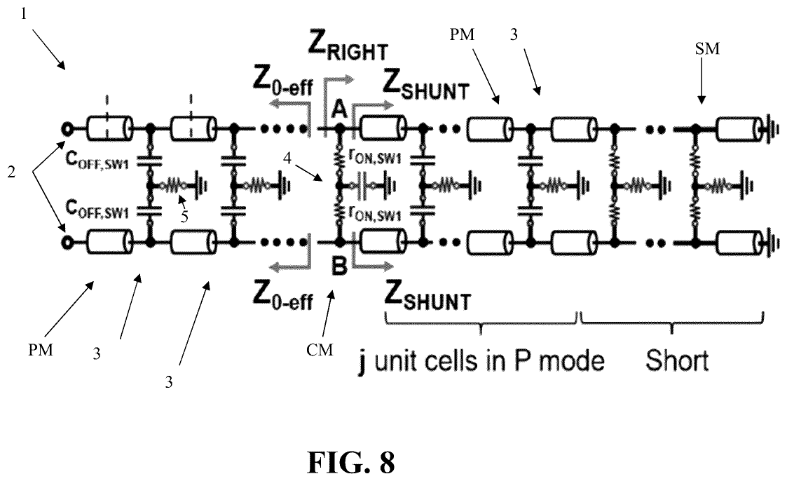

For example, an embodiment that can be configured as a quarter-wave impedance transformer terminated by a short can be formed by: 1) having j unit cells in propagation mode PM after the connection mode unit cell 3 for a 90° phase shift at the operation frequency and 2) having the rest of the unit cells 3 in the short mode SM that are downstream of the connection mode unit cell and the downstream propagation mode unit cells 3. FIG. 8 illustrates an example of such a configuration.

The apparatus 1 can have only a single unit cell 3 in the connection mode CM. For all phase states; the overall insertion loss can remain constant across different phase settings, as it can be dominated by the transition loss at the unit cell in the connection mode CM. This feature can address the tradeoff between insertion loss and phase resolution/tuning range as well as large loss variation across different phase states. For example, the overall insertion loss can be determined by: 1) the insertion loss of the input and output matching networks to transform Z_{0,eff} to a pre-selected value; 2) the propagation loss that can occur when a signal propagates over cascaded unit cells 3 in the propagation mode PM before/after transition between the transmission lines via the transmission line connection 4 of the unit cell 3 in the connection mode CM configuration; and 3) transition loss.

### Experiments, Measurements and Simulation Results

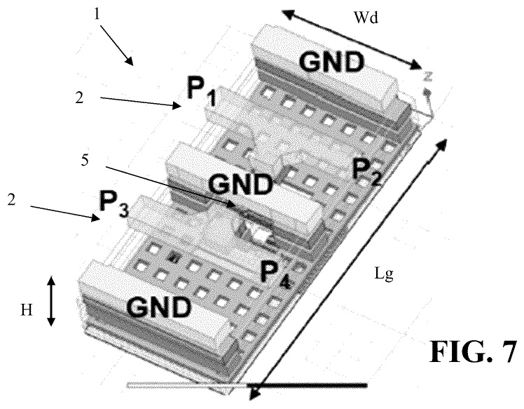

A first prototype phase shifting apparatus 1 was configured as a phase shifter configured for operating at 140 GHz using a 45-nm Radio Frequency Silicon-on-Insulator (RFSOI) chip. The phase shifter had N cascaded unit cells 3. FIG. 7 shows the 3-D layout of the unit cell. The unit cell of the first prototype phase shifter was formed on a chip having a width W_{d} of 35 micrometers and a length L_{g} of 75 micrometers. The first unit cell included a first transmission line 2 having a first port P1 and a second port P2 at its terminal ends. The first unit cell also included a second transmission line having a first port P3 and a second port P4 at its opposite ends.

The first prototype was designed with metal-oxide semiconductor (NMOS) transistors to function as switches 3s for the first and second switches SW1, SW2 for the different unit cells 3 and the parallel transmission lines 2 were implemented with coplanar waveguides.

The transistor switch layout for the first prototype was RC-extracted using Cadence Physical Verification System and Cadence Quantus Extraction Solution (PVS-QRC), and the surrounding electromagnetic (EM) structure was modeled by EMX Designer. The switch network that connects the two coplanar waveguides was implemented with two transistors in series as first switches SW1 and one shunt transistor in the middle between the two first switches SW1 as a second switch SW2 for the unit cells 3.

For propagation mode configurations, the second switch SW2 was turned on. For the short mode, the second switch SW2 was also turned on. The second switch SW2 was turned on for propagation mode to minimize capacitive coupling between the forward and reverse signaling paths for the transmission path of travel 8 of the first prototype. It was found that improved isolation could be provided with the second switch SW2 in its ON-state to help enhance the uniformity of phase steps and insertion loss for different configurations in which a different one of the unit cells 3 was utilized in the connection mode CM for the first prototype.

The phase shift per unit cell 3 in the propagation mode PM for the first prototype can given by Δθ being equal to ω multiplied by the square root of L₀(C₀+C_{OFF}) of the first switch SW1) where L₀ and C₀ are the inductance (L) and capacitance (C) of the transmission line 2 per unit cell 3, respectively, C_{OFF,SW1} is the parasitic capacitance of the first switch SW1 and the effective characteristic impedance for cascaded unit cells 3 in the propagation mode PM is Z_{0,eff}=the square root of L₀ divided by the sum of C₀ and C_{OFF} for the first switch SW1.

For a higher phase resolution (smaller Δθ), the size of the first switch SW1 can be reduced for a smaller C_{OFF} of the first switch SW1 while the reduced size of first switch SW1 can increase the resistance of the first switch SW1 (r_{ON}, SW1) thereby increasing the signal loss at the unit cell 3 in connection mode CM and the unit cells 3 in short modes. Based on the tradeoff between the phase resolution and insertion loss, the selected Δθ and Z_{0,eff} for the first prototype were 22.5° at 140 GHz for 45° phase steps and 22′Ω, respectively.

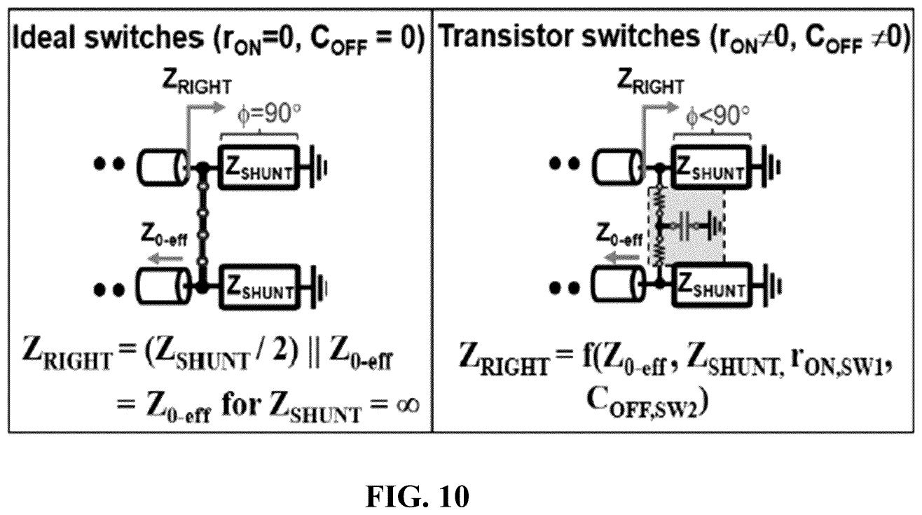

For uniform phase steps and low insertion loss over phase settings, signal reflection at the transition where the signal is redirected to the other transmission line can be minimized. For example, for an impedance matching condition (Z_{RIGHT}=Z_{0,eff}) for the minimum reflection with ideal switches (r_{ON}=0 and C_{OFF}=0) and transistor switches, where Z_{RIGHT} is the impedance seen at the transition of the signal (e.g. resistance at the point where the signal is passed from the first transmission line 2 to the transmission line connection 4 for being routed along the second transmission line 2). FIG. 10 schematically illustrates such relationships.

With ideal switches, Z_{RIGHT} can be equal to the parallel combination of two quarter wavelength transmission lines 2 with the short termination (Z_{SHUNT}/2) and Z_{0,eff} presented from the second transmission line 2. This can lead to the impedance matching condition, Z_{RIGHT}=Z_{0,eff}, since Z_{SHUNT}>>Z_{0,eff}. For transistor switches with finite r_{ON}, C_{OFF}, Z_{RIGHT} can be determined by Z_{0,eff}, Z_{SHUNT}, TON for the first switch SW1, and C_{OFF}, for the second switch SW2. For a given switch and transmission line dimensions, Z_{RIGHT} can be tuned with Z_{SHUNT} by changing the number of the unit cells 3 in the propagation mode PM after the unit cell 3 that is in the connection mode CM. Based on the simulated Z_{RIGHT}, Z_{SHUNT}, and transition loss for different numbers j of unit cells 3 that are positioned between the short mode SM unit cells 3 and the connection mode CM unit cell 3, a value of j=2 was chosen for the first prototype based on the simulated matching conditions as this condition was found to provide the lowest insertion loss over a wider bandwidth for the first prototype. However, in simulation work done to develop the first prototype, it was found that j=4 can meet the quarter wavelength condition for Δθ of Δθ=22.5°, but was not optimal when the switch model based on transistors was taken into account for the first prototype.

Since r_{ON} for the first switch SW1 can be comparable to Z_{0,eff}, there is a nonnegligible transition loss determined by the voltage ratio between nodes A and B of the transmission line connection 4 shown in FIG. 8 for the first prototype. This transition loss can be approximated under the impedance matching condition at this transition by a formula of:

$$\frac{{V}_{B}}{{V}_{A}} ≃ \frac{( {Z}_{0 , eff} ‖ {Z}_{shunt} )}{( {Z}_{0 , eff} ‖ {Z}_{shunt} ) + 2 {r}_{ON , SW 1}}$$

wherein V_{A} is voltage of node A, V_{B} is the voltage of node B, Z_{0,eff}, is the effective characteristic impedance Zₛₕᵤₙₜ is the impedance that the rest of the phase shifter presents after the unit cell in connection mode CM, rₒₙ is the resistance of the first switch SW1 of the unit cell in connection mode CM that is in its on position.

In evaluating the first prototype, insertion loss was also calculated with respect to the size of first switch SW1 for different r_{ON}C_{OFF} values. In those calculations, it was assumed that: 1) the size of the second switch was proportional to that of the first switch SW1 to keep extra loss due to C_{OFF,SW2} constant; 2) that the Z_{SHUNT} is properly adjusted for the impedance matching condition; and 3) Δθ is kept to be 22.5° by adjusting L₀ and C₀ of the transmission lines for constant Z₀ which equals the square root of L₀ divided by C₀ to equal 60′Ω. The calculated insertion loss was found to decrease with a larger size of the first switch SW1 and a minimum value was found to be beyond a certain size of the first switch SW1. The minimum insertion loss for the first prototype was also determined by the intrinsic r_{ON}C_{OFF} values of transistors that were used as the switches given by the process technology. For a 45 nm RFSOI process, the r_{ON}C_{OFF} value is about 180 fs for RC-extracted transistors used as first and second switches given the minimum channel length. A smaller r_{ON}C_{OFF} value can produce a lower transition loss and an advanced process node with a 50% lower r_{ON}C_{OFF} value than a 45 nm RFSOI process may be able to reduce the insertion loss by about 3 dB for the first prototype that was evaluated based on the calculations that were performed.

For example, process design kits (PDK) super-low threshold voltage (SLVT) NMOS devices in GF's 22FDX process can exhibit an r_{ON}C_{OFF} value of ˜100 fs. It was found that the PDK-based simulation results were matched with the calculations that were performed closely. Based on the above V_{B}/V_{A} calculation, it was found that the minimum transition loss (e.g. the maximum VB/VA) with respect to the first switch SW1 size is approximately provided by:

$${( \frac{{V}_{B}}{{V}_{A}} )}_{MAX} = \frac{1}{\sqrt{1 + {K}^{2}} + K}$$

wherein K is equal to 200 r_{ON}C_{OFF})/Δθ. This implies that the minimum achievable transition loss for the first prototype can increase with higher frequency and smaller phase steps (e.g. higher resolution), while a better process technology with lower r_{ON}C_{OFF} can reduce it.

The minimum transition loss with respect to frequency for different Δθ and r_{ON}C_{OFF} was also calculated. The transition loss was found to increase with a smaller Δθ, implying the tradeoff between loss and phase resolution. A smaller Δθ reduces L₀ for a given switch size, reducing Z_{0,eff} and increasing the transition loss. For the first prototype integrated circuit (IC), Δθ of 22.5° was selected.

The overall insertion loss of the first prototype was determined by 1) the insertion loss of the input and output matching networks to transform Z_{0,eff} to a pre-selected value of 50′Ω; 2) the propagation loss that can occur when a signal propagates over cascaded unit cells 3 in the propagation mode PM before/after transition between the transmission lines via the transmission line connection 4 of the unit cell 3 in the connection mode CM configuration; and 3) transition loss that was calculated as noted above.

The overall insertion loss for the first prototype is mainly determined by the transition loss. The insertion loss of the matching networks increases with a larger SW1 size. As the size of first switch SW1 increases, Z_{0,eff} decreases for a given Δθ, as L₀ needs to be reduced. The decrease in Z_{0,eff} increases the impedance transformation ratio given by Q=((50/Z_{0,eff})−1)^{1/2} and increases the insertion loss of the matching network given by:

$$IL = \frac{1}{1 + \frac{Q}{{Q}_{L}}} \cdot \frac{1}{1 + \frac{Q}{{Q}_{C}}}$$

wherein Q_{L} and Q_{C} are the quality factors of the inductor and capacitor that form the matching network. For the loss calculations, Q_{L} and Q_{C} were assumed to be 48 and 10 based on the simulation of the PDK components. It is noted that the simulated propagation loss is smaller than 1.4 dB for all phase shift states for the first prototype. Since only the propagation loss among the three loss contributors is dependent on the phase state that corresponds to the number of unit cells in propagation mode PM upstream of the unit cell in the connection mode CM, the variation of the overall insertion loss over phase states can be kept low, which is a desirable feature to enable orthogonal phase and gain control in phased array front-ends. Based on: 1) the overall insertion loss that was calculated for the first prototype and 2) the minimum inductance that can be reliably designed using a transmission line 2, the selected size of the first switch SW1 is 25 μm for the first prototype IC.

A second prototype of the phase shifting apparatus 1 was fabricated and designed as a 5-bit digital phase shifter. The second prototype was a 140 GHz prototype phase shifter that used 12 cascading unit cells 3 for interconnecting first and second transmission lines 2. The cascading unit cells 3 operated with 45° steps (Δθ=22.5°) over a 360° tuning range as can be appreciated from the below configuration table for the second prototype.

Second Prototype Configuration Table;

| Unit | | | | | | | | | | | | |
|---|---|---|---|---|---|---|---|---|---|---|---|---|
| Cell | | | | | | | | | | | | |
| number | 1 | 2 | 3 | 4 | 5 | 6 | 7 | 8 | 9 | 10 | 11 | 12 |
| 0° | C | P | P | S | S | S | S | S | S | S | S | S |
| 45° | P | C | P | P | S | S | S | S | S | S | S | S |
| 90° | P | P | C | P | P | S | S | S | S | S | S | S |
| 135° | P | P | P | C | P | P | S | S | S | S | S | S |
| 180° | P | P | P | P | C | P | P | S | S | S | S | S |
| 225° | P | P | P | P | P | C | P | P | S | S | S | S |
| 270° | P | P | P | P | P | P | C | P | S | S | S | S |
| 315° | P | P | P | P | P | P | P | C | S | S | S | S |

*Propagation Mode PM is “P”, Connection Mode CM is “C”, and Short Mode SM is “S” in the Configuration Table.

As can be seen from the above configuration table, for each phase state, two unit cells are set to the propagation mode PM after the unit cell in the connection mode CM, and the rest of the unit cells are set to the short mode SM. Two “dummies” were added as unit cells numbered 11 and 12 were provided at the end to provide consistent Z_{SHUNT} for uniform phase steps and insertion loss for the second prototype.

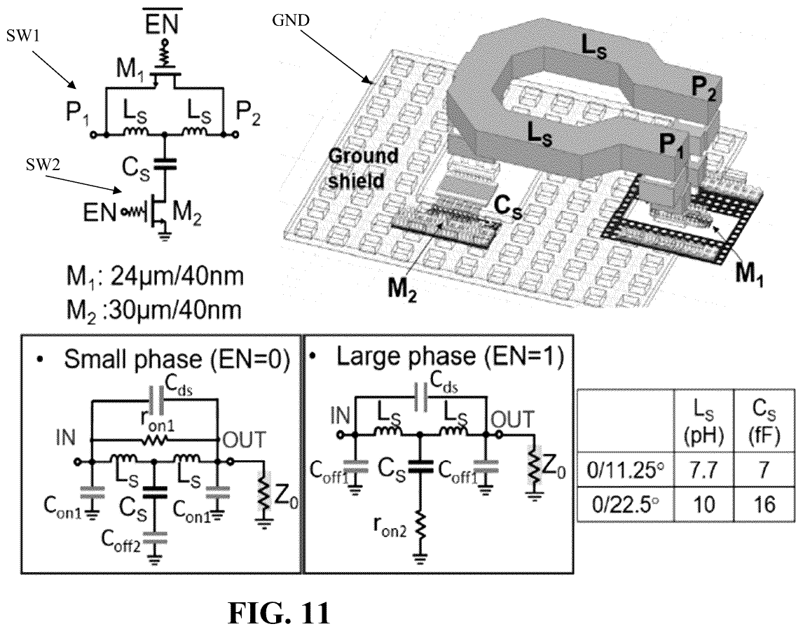

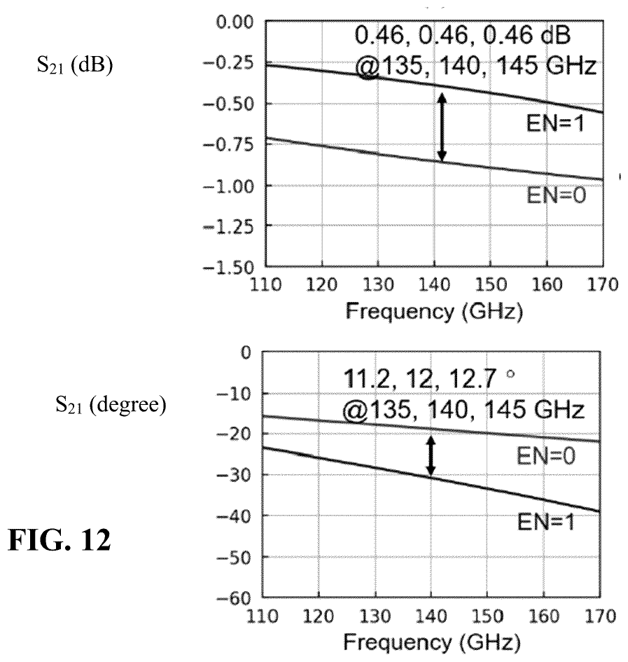

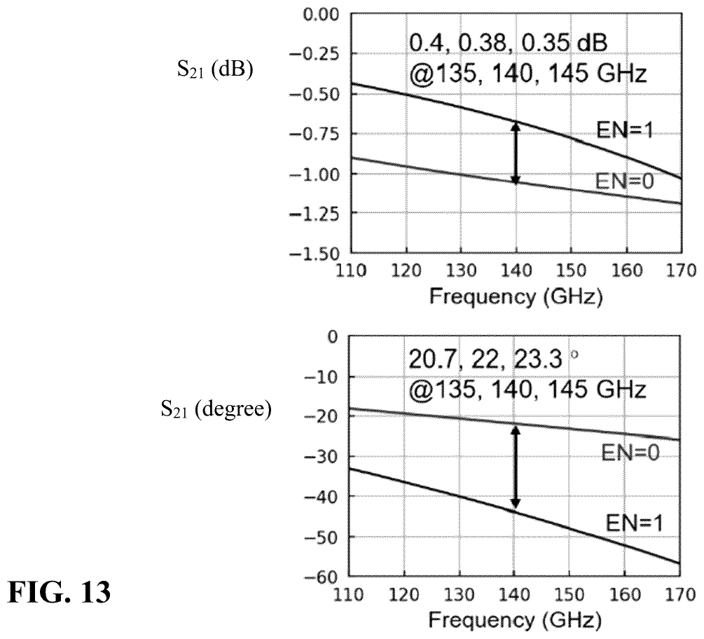

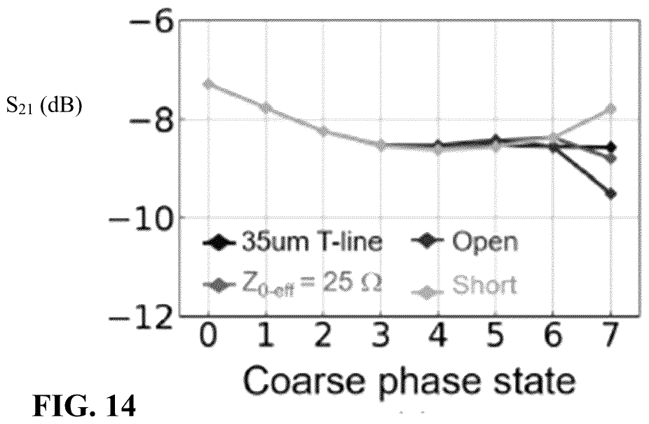

To improve the phase resolution to 11.25°, two 1-bit fine-tuning phase shifters based on a switched inductor-capacitor (L-C) topology were added to complete the second prototype that was configured as a 5-bit digital phase shifter having multiple metal-oxide semiconductor field-effect transistor (MOSFET) switches (M₁, M₂). A schematic of the fine-tuning phase shifters with a 3-D layout view is shown in FIG. 11. The schematics for 0°/11.25° and 0°/22.5° fine-tuning phase shifters are identical with different inductor (L) and capacitor (C) values with a 25-′Ω interface as shown in the above table. The capacitor was implemented with a vertical natural capacitor (VNCAP). A large phase shift occurs when M₁ is off and M₂ is on to switch to larger inductance and capacitance in the signal path. As shown in FIGS. 12 and 13, the designed 1-bit fine-tuning phase shifters provided a higher insertion loss for the small-phase states (EN=0) than for the large-phase states (EN=1). The insertion loss for the small-phase states is mainly determined by a voltage divider formed with the load impedance, Z₀, and the parallel impedance of 2L_{S} and r_{ON1} as shown in FIGS. 12 and 13.

The effect of C_{ds} and C_{ON1,2} on the small-phase state is not significant for the selected size of M₁, where C_{ds} is a parasitic capacitance between the drain and the source of M₁ formed by the electrical coupling through the drain and source metal lines and via stacks. A larger size of M₁ reduces r_{ON1}, thereby improving the insertion loss for the small-phase states. However, an increase in the size of M₁ also increases C_{ds} and C_{off1}, degrading the linear phase shift and broad matching behavior determined by a T-section formed with L_{S} and C_{S} for the large-phase state. Based on the tradeoff between small and large phase state performances, the selected size of M₁ for the second prototype was 24 μm with r_{ON1} of ˜14′Ω, achieving an insertion loss lower than 1 dB for the small-phase states along with L_{S} (j13.5′Ω for 0°/11.25° and j17.7′Ω for 0°/22.5° at 140 GHz). The selected size of M₂ for the second prototype was 30 μm, considering that: 1) a larger size of M₂ reduced the insertion loss for the large phase state and 2) the insertion loss variation between the small and large phase states can be smaller than 0.5 dB. The simulated phase shift and insertion loss variation between the two states were) 12° (22°) and 0.5 dB (0.4 dB) at 140 GHz for the designed) 0°/11.25° (0°/22.5°) phase shifter as shown in FIGS. 12 and 13.

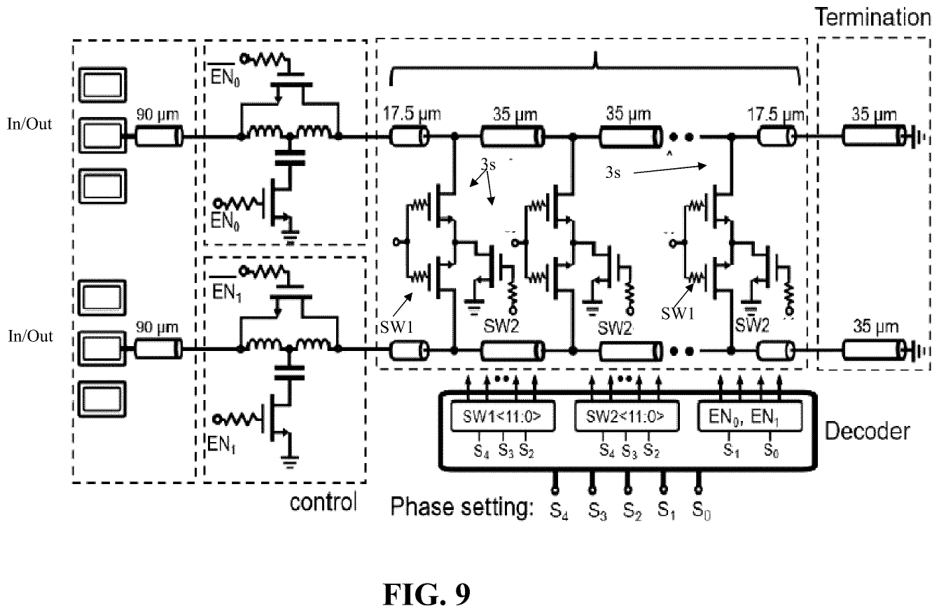

FIG. 9 illustrates the second prototype that utilized 12 unit cells with 45° steps that was integrated with an ON-chip decoder. The second prototype also integrates a 1-bit 0°/11.25° fine-tuning phase shifter at the input and 1-bit 0°/22.5° fine-tuning phase shifter at output as a control for the transmission of signals between ports of the transmission lines 2. The switch positions for the unit cells were controlled via phase settings S₂, S₃, and S₄ (3-bit) for different unit cells. Fine phase shift EN₀ for 0°/11.25° phase control and EN₁ for 0°/22.5° phase control can be applied via different settings providable by the decoder through settings S₀ and S₁. The pad capacitance and 90-μm transmission line form an L-matching network to transform Z_{0,eff}=22′Ω to 50′Ω. The termination of the 12-cascaded unit cells 3 was selected for uniform phase and insertion loss over phase states.

In FIG. 9, segments of each transmission line 2 are indicated via a cylindrical image with the spaced apart unit cells 3 shown schematically between different spaced apart sections of each of the parallel transmission lines 2. The second port (P2, P4) for each transmission line can be coupled to ground GND. The first ports (P1, P3) can be positioned to receive a signal or output a signal (In/Out).

The second prototype was utilized to perform measurements and also utilized in simulations to evaluate the second prototype and how it can perform under different conditions.

The second prototype was fabricated in Global-Foundries' 45-nm RFSOI process. The chip area was only 0.04 mm². The fabricated integrated circuit (IC) was characterized on a wafer for a positive supply voltage (VDD) of 1.0 V by measuring S-parameters with Keysight N5242B PNA-X, N5292A mmWave test controller, and N5262BW06 D-band Vector Network Analyzer Extension (VNAX) modules. An input power level applied to the IC from the VNAX module was calibrated with a VDI-Erickson PM5B power meter. The RF input and output ground-signal-ground (GSG) pads were probed with 100-μm pitch Cascade Infinity WR6 waveguide probes. The measurement system was calibrated to the probe tips using the two-port short-open-load-through method using a Cascade Microtech 138-357 calibration substrate.

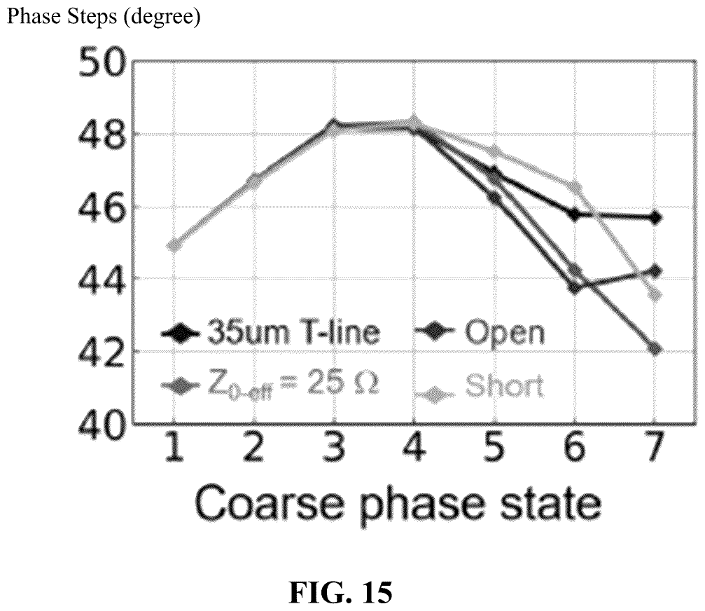

FIGS. 14 and 15 show the simulated insertion loss and phase shift at 140 GHz with respect to phase setting for different types of terminations such as short, open, Z_{0,eff}, and shorted 35-μm transmission line for the evaluated second prototype. Based on the simulation results, a shorted 35 μm transmission line was chosen for termination for the second prototype.

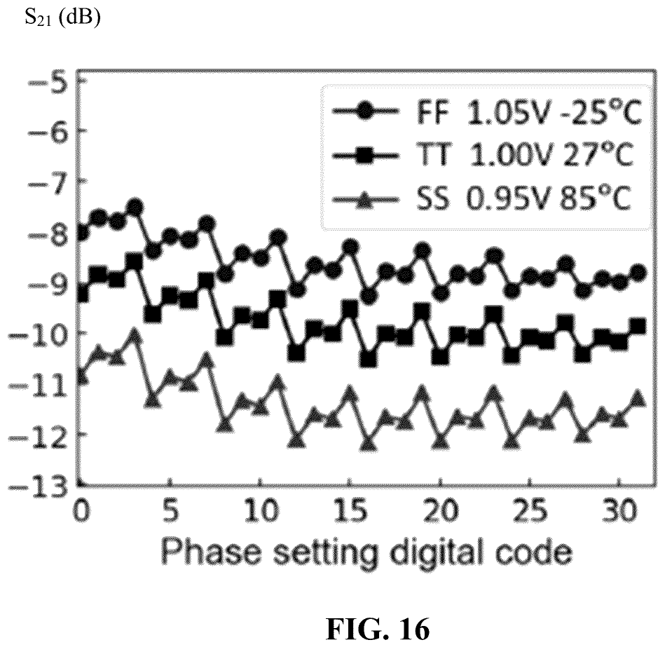

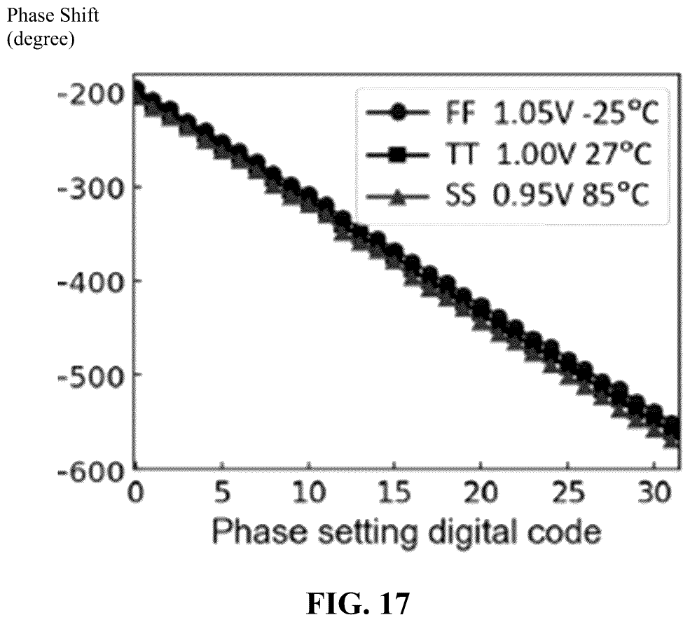

FIGS. 16 and 17 show the simulated insertion loss and phase shift at 140 GHz with respect to phase settings over three different PVT corners: (TT, 1.0 V, 27° C.), (SS, 0.95 V, 85° C.), and (FF, 1.05 V, −25° C.). While the average insertion loss varies from 8.9 to 11.3 dB, the rms phase errors and gain errors are kept lower than 2.4° and 0.5 dB for all corners, respectively. The robust gain and phase error controls over different PTV corners demonstrate the calibration-free feature of the second prototype.

Input Third-Order Intercept Point (IIP3) and Output Third-Order Intercept Point (OIP3) were simulated for the second prototype with respect to phase states for linearity characterization. The simulated IIP3 ranged from 23.7 to 24.9 dBm and OIP3 varied from 13.6 to 15.9 dBm over different phase states, which presents excellent linearity for the second prototype.

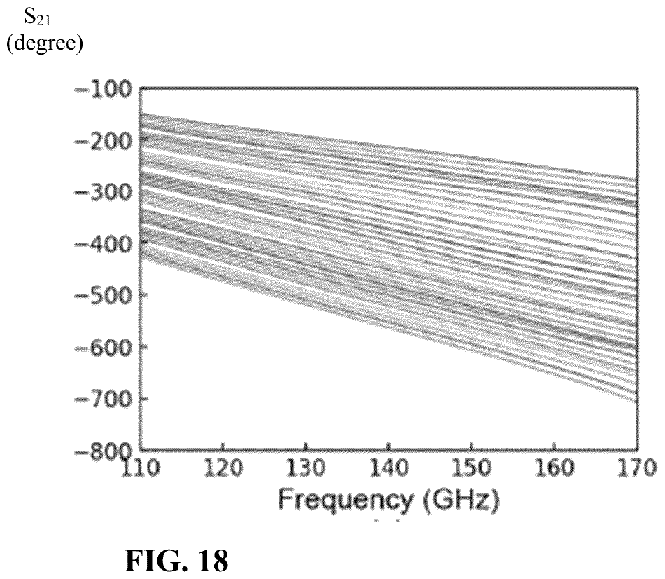

FIG. 18 shows the measured phase shift for all phase states with respect to frequency for the second prototype. The measured phase steps are uniform over a wide bandwidth and the phase tuning range increases with frequency due to the true time delay nature of the proposed phase shifter, reporting a phase tuning range greater than 360° at frequencies higher than 140 GHz.

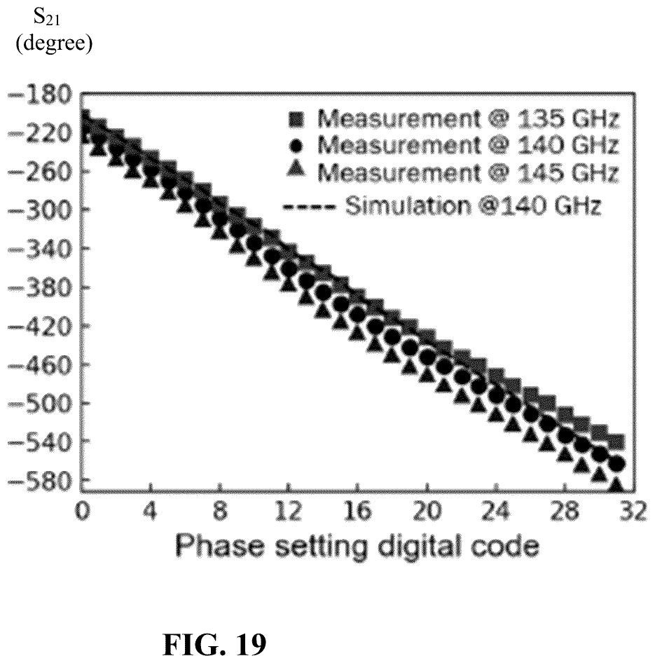

FIG. 19 shows the measured phase shift at 135, 140, and 145 GHz across phase settings in comparison to the simulation to present a linear phase control feature achieved by the proposed phase shifter. While the phase shift between the simulation and measurement are matched closely, there is some discrepancy in the middle of the curves due to the nonuniform steps of the measured phase shift. A potential source of such discrepancy is an imperfect impedance matching condition at the transition. When some portion of an input signal is reflected from the transition due to imperfect impedance matching, the phase might not linearly increase with propagation distance due to standing-wave formation.

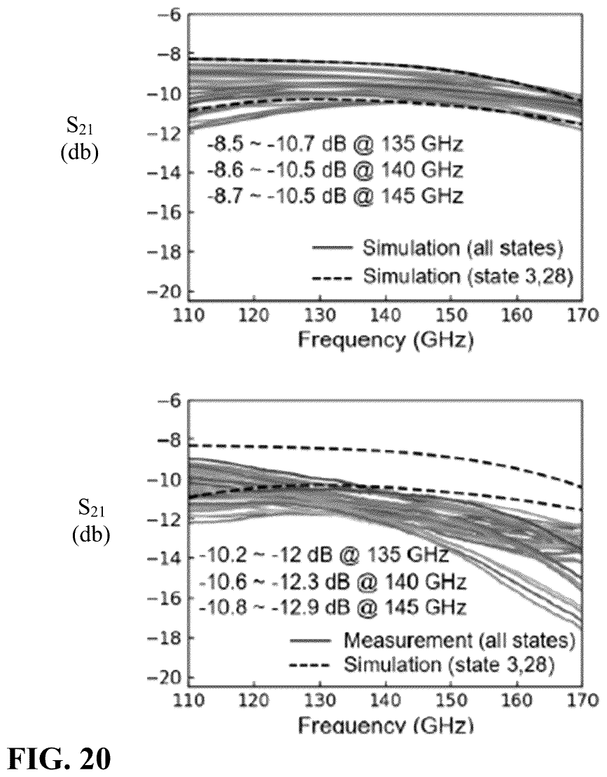

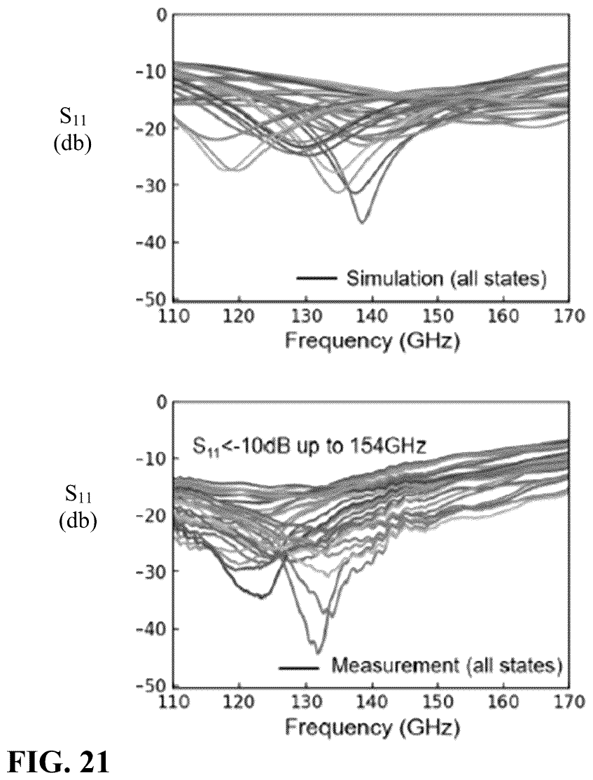

FIGS. 20 and 21 show the measured insertion loss and input return loss for all phase states in comparison to the simulation results for the second prototype. The measured insertion loss ranges from 10.6 to 12.3 dB at 140 GHz. The insertion loss variation across different phase settings is less than +0.8 dB. The measured average insertion loss is ˜1.7 dB higher than the simulated value at 140 GHz. The potential sources of such discrepancies are inaccurate modeling of pads, transistor switches, and electromagnetic coupling at high frequencies.

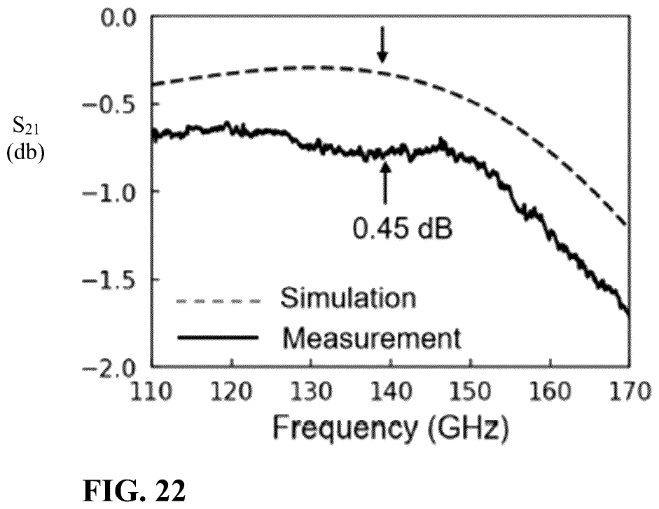

The loss from the pads and interconnects is characterized using a breakout as shown in FIG. 22. The discrepancy between the simulation and measurement is 0.45 dB at 140 GHz. The measured input return loss of the proposed phase shifter is greater than 10 dB at frequencies up to 154 GHz for all phase states.

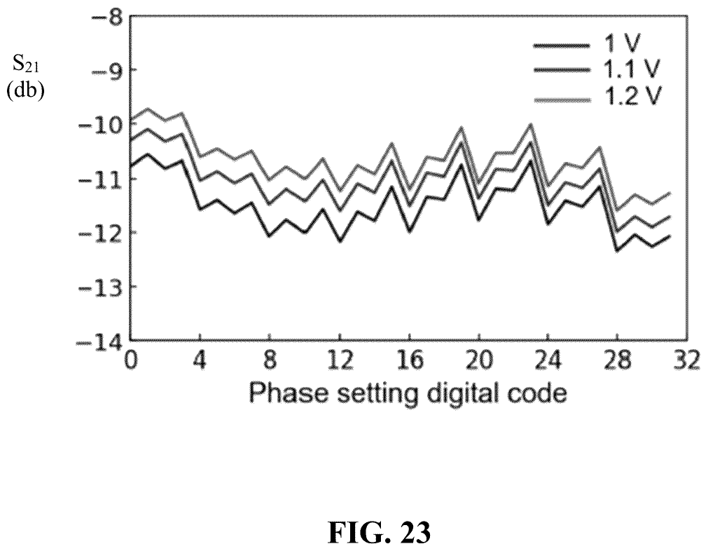

The increase in VDD decreases the insertion loss further due to smaller r_{ON} as shown in FIG. 23. The measured insertion loss is reduced to 9.7˜11.6 dB for a VDD of 1.2 V.

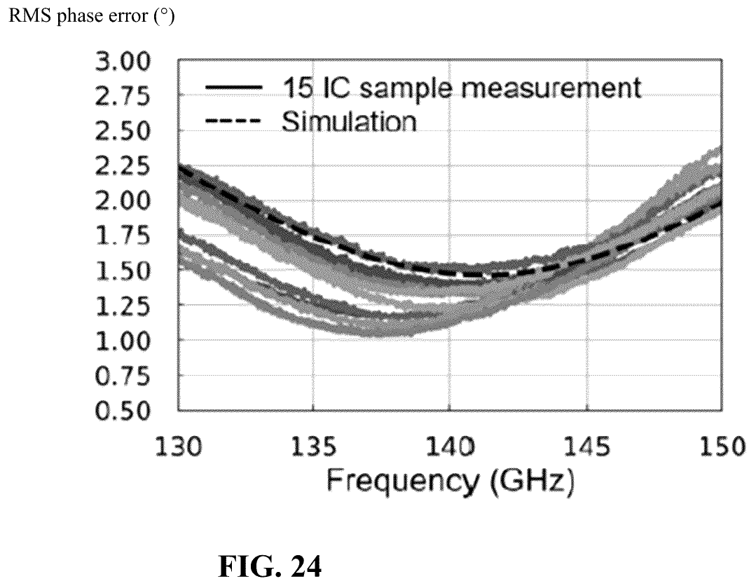

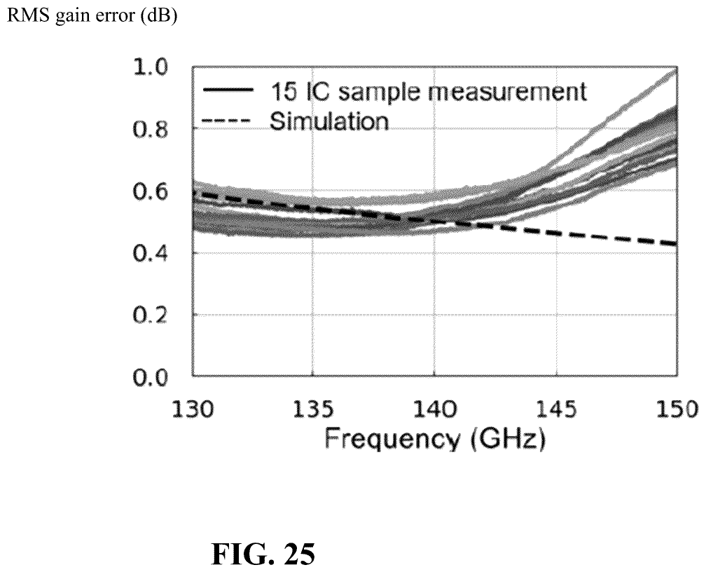

FIGS. 24 and 25 show the measured rms phase and gain errors for 15 IC samples in comparison to the simulation results. The rms phase error is lower than 2.4° from 130 to 150 GHz for all samples and reports the mean of 1.3° at 140 GHz which is the lowest among published phase shifters in similar frequency ranges. The rms gain error with respect to the average gain is lower than 1 dB from 130 to 150 GHz for all samples and the mean of the rms gain error is 0.52 dB at 140 GHz.

Measurements for rms phase errors, rms gain errors, and average insertion loss at 135, 140, and 145 GHz for 15 IC samples of the second prototype were also made. Small variation over different samples demonstrated the calibration-free feature of the second prototype. The demonstrated high phase control accuracy, uniform insertion loss over phase states, and small chip-to-chip variation are highly desirable features to reduce the complexity of the front-end control and calibration in a large-scale phase array, for example.

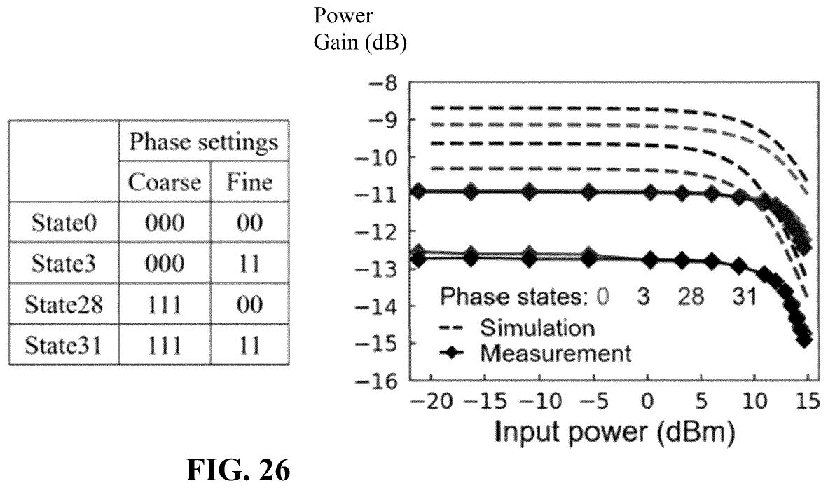

FIG. 26 shows the measured large-signal gain with respect to input power at 140 GHz for different phase settings. Since the nonlinearity of transistor switches can determine the overall linearity and it varies for ON and OFF states, four different phase states were selected based on the possible combinations of the minimum and maximum phase states of coarse and fine-tuning phase shifters for evaluation of the second prototype. The measured input P1 dB ranged from 12.9 to 14 dBm, which is greater than the simulation results (10-12.5 dBm). The discrepancy is due to higher insertion loss of the fabricated ICs and large-signal modeling inaccuracy of passive transistors. The measured linearity is superior to those reported in the active-type modulators in similar frequency bands.

The second prototype was found to provide superior phase accuracy, low loss variation over phase states, high linearity, and compact chip area, while still providing high phase resolution and low insertion loss. The second prototype may be the first bi-directional, calibration-free phase shifter among the phase shifters reported in literature at D-band.

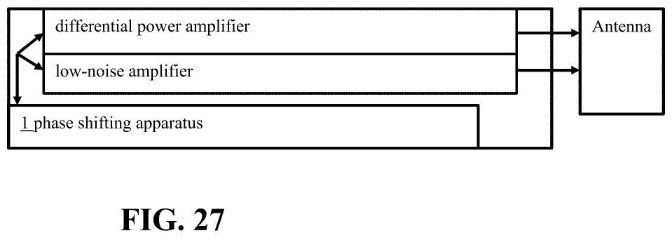

Embodiments of the phase shifting apparatus 1 can be integrated into different types of communication devices and electrical devices. For example, FIG. 27 is a schematic block diagram of an exemplary embodiment of a D-band phased array transceiver integrated with an exemplary embodiment of the phase shifting apparatus 1. The D-band phased array transceiver can include a power amplifier and a low-noise amplifier with single-ended input and output using baluns to share the phase shifting apparatus via a single-pole double-throw (SPDT) switch. The other port of the phase shifting apparatus can be connected to a passive single-ended power combiner and splitter for a compact chip area. The phase shifting apparatus 1 can be placed at the last stage of the receiver chain to minimize the noise contribution to the overall noise figure and at the first stage of the transmitter chain to minimize the degradation of the overall transmitter efficiency. As can be appreciated from the above evaluation of prototypes of the phase shifting apparatus 1, an embodiment of the phase shifting apparatus 1 can be positioned and configured to enable a compact phased array transceiver frontend that can easily fit within a λ/2 (=1.07 mm at 140 GHz) lattice for a scalable AiP integration.

As can be appreciated from the above discussed sets of different experiments and modeling, embodiments of the phase shifting apparatus 1 and phase shifting process can provide significant improvement in data transmissions that can help facilitate an improvement in controlling for time delays associated with transmission of data via transmission lines while also avoiding data loss associated with transmission of the data. Some embodiments of the apparatus can be configured for positioning in a computer chip, microchip, nanochip, or other type of device configured for data processing, data transmission, or signal transmission.

For example, embodiments can provide a low-loss passive phase shifter with calibration-free, precise phase control by exploiting a digitally programmable trombone-like passive network. Some embodiments of the phase shifting apparatus can be fabricated in a 45-nm RFSOI technology to achieve a low rms phase error (e.g.) 1.2° without calibration and the first bi-directional 360° tuning with no direct current power consumption among state-of-the-art D-band phase shifters. Other embodiments may utilize other types of technology or fabrication processing to provide such features as well. As can be appreciated from the conducted experimental work, embodiments can also exhibit low insertion loss and compact chip area.

As can be appreciated from the above, embodiments of the apparatus and process can be adapted to meet a particular set of design criteria. For instance, the particular type of circuitry elements and/or transmission lines that may be used (e.g. structure, number of switches, configuration of the transmission line structures, etc.) can be adjusted to meet a particular set of design criteria. As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain present preferred embodiments of the phase shifting apparatus and phase shifting process, as well as embodiments of methods for making and using the same have been shown and described above, it is to be distinctly understood that the invention is not limited thereto but may be otherwise variously embodied and practiced within the scope of the following claims.

What is claimed is:

1. A phase shifting apparatus comprising:
a first transmission line;
a second transmission line;
a plurality of spaced apart unit cells positioned between the first transmission line and the second transmission line, the plurality of spaced apart unit cells including at least one first unit cell, a second unit cell, at least one third unit cell, and at least one fourth unit cell;
each of the unit cells including:
at least one first switch positioned between the first transmission line and the second transmission line, the at least one first switch configured to adjust between an on position and an off position, the at least one first switch configured so that, in the off position, the at least one first switch avoids coupling the first transmission line to the second transmission line, and, in the on position, the at least one first switch couples the first transmission line to the second transmission line to form a transmission line connection between the first transmission line and the second transmission line so data is passable from the first transmission line to the second transmission line along a transmission path of travel;
a second switch being positionable adjacent the at least one first switch, the second switch being adjustable between an on position that couples the at least one first switch to ground and an off position that prevents the second switch from coupling the at least one first switch to the ground,
each of the unit cells being adjustable into multiple different modes of operation, the modes of operation including a propagation mode, a connection mode, and a short mode, the propagation mode being a mode in which the at least one first switch is in the off position and the at least one second switch is in the on position, the connection mode being a mode in which the at least one first switch is in the on position to form the transmission line connection and the second switch is in the off position, and the short mode being a mode in which the at least one first switch is in the on position and the second switch is in the on position;
the unit cells being positioned and configured so that the at least one first unit cell is positionable in the propagation mode, the second unit cell is positionable in the connection mode, the at least one third unit cell is positionable in the propagation mode, and the at least one fourth unit cell is positionable in the short mode.

2. The apparatus of claim 1, wherein the at least one first switch includes at least one transistor and the second switch includes a transistor.

3. The apparatus of claim 1, wherein the at least one first switch includes at least one metal-oxide semiconductor (NMOS) transistor and the second switch includes a NMOS transistor.

4. The apparatus of claim 1, wherein the at least one first unit cell includes between two first unit cells and seven first unit cells, the second unit cell includes a single second unit cell, the at least one third unit cell includes between one third unit cell and four third unit cells, and the at least one fourth unit cell includes between nine fourth unit cells and five fourth unit cells.

5. The apparatus of claim 1, wherein the second unit cell is between the at least one first unit cell and the at least one third unit cell and the at least one third unit cell is between the second unit cell and the at least one fourth unit cell.

6. The apparatus of claim 1, wherein the at least one first switch includes two first switches arranged in series.

7. The apparatus of claim 1, wherein the at least one first switch includes multiple first switches arranged in series.

8. The apparatus of claim 1, wherein the apparatus is integrated into a D-band phased array transceiver.

9. A phase shifting apparatus comprising:
a first transmission line;
a second transmission line;
a plurality of spaced apart unit cells positioned between the first transmission line and the second transmission line, each of the unit cells including:
at least one first switch positioned between the first transmission line and the second transmission line, the at least one first switch configured to adjust between on position and an off position, the at least one first switch configured so that, in the off position, the at least one first switch avoids coupling the first transmission line to the second transmission line, and, in the on position, the at least one first switch couples the first transmission line to the second transmission line to form a transmission line connection between the first transmission line and the second transmission line so data is passable from the first transmission line to the second transmission line along a transmission path of travel;
a second switch being positionable adjacent the at least one first switch, the second switch being adjustable between an on position that couples the at least one first switch to ground and an off position that prevents the second switch from coupling the at least one first switch to the ground,
each of the unit cells being adjustable into multiple different modes of operation, the modes of operation including a propagation mode, a connection mode, and a short mode, the propagation mode being a mode in which the at least one first switch is in the off position and the at least one second switch is in the on position, the connection mode being a mode in which the at least one first switch is in the on position to form the transmission line connection and the second switch is in the off position, and the short mode being a mode in which the at least one first switch is in the on position and the second switch is in the on position;
the unit cells being positioned and configured so that a single one of the unit cells is in the connection mode, more than two of the unit cells are in the propagation mode, and more than two of the unit cells are in the short mode.

10. The apparatus of claim 9, wherein the at least one first switch includes at least one transistor and the second switch includes a transistor.

11. The apparatus of claim 9, wherein the at least one first switch includes at least one metal-oxide semiconductor (NMOS) transistor and the second switch includes a NMOS transistor.

12. The apparatus of claim 9, wherein the at least one first switch includes two first switches arranged in series.

13. The apparatus of claim 9, wherein the at least one first switch includes multiple first switches arranged in series.

14. The apparatus of claim 9, wherein the apparatus is integrated into a D-band phased array transceiver.

15. A process of shifting a phase of a signal as the signal is passed from a first transmission line to a second transmission line, the process comprising:
passing a signal along a first transmission line;
passing the signal along a transmission line connection between the first transmission line and the second transmission line provided by at least one first switch of a connection mode unit cell positioned between the first transmission line and the second transmission line, a second switch of the connection mode unit cell being in an off position;
passing the signal from the transmission line connection to the second transmission line along a transmission path of travel;
preventing a loss of data as the signal is passed from the first transmission line to the second transmission line along the transmission path of travel by configuring multiple unit cells positioned between the first transmission line and the second transmission line and also positioned downstream of the connection mode unit cell in a short mode of operation.

16. The process of claim 15, also comprising:
preventing a loss of data as the signal is passed from the first transmission line to the second transmission line along the transmission path of travel by configuring one or more unit cells located between the connection mode unit cell and the short mode unit cells in a propagation mode of operation.

17. The process of claim 15, wherein there is at least one first unit cell positioned between the first transmission line and the second transmission line that is configured in a propagation mode and is located upstream of the connection mode unit cell.

18. The process of claim 15, comprising:
configuring one or more first unit cells upstream of the connection mode unit cell into a propagation mode.

19. The process of claim 15, comprising:
configuring one or more first unit cells upstream of the connection mode unit cell into a propagation mode and configuring one or more third unit cells positioned between the connection mode unit cell and the short mode unit cells into the propagation mode.

20. The process of claim 19, wherein the propagation mode includes at least one first switch positioned between the first transmission line and the second transmission line being in an off position and a second switch positioned adjacent to the at least one first switch being in an on position to couple the at least one first switch to ground.
